(19) United States
(12) Patent Application Publication
(10) Pub. No.: US 2026/0365570 A1
(43) Pub. Date: Nov. 19, 2026

(54) BONDED SUBSTRATE ARRANGEMENT AND METHOD FOR MANUFACTURING OF SUCH AN ARRANGEMENT

(71) Applicants: SCHOTT AG, Mainz (DE); SCHOTT PRIMOCELER OY, Tampere (FI)

(72) Inventors: Jens Ulrich THOMAS, Mainz (DE); Antti MÄÄTTÄNEN, Tampere (FI); Thorsten DAMM, Mainz (DE)

(21) Appl. No.: 19/142,718

(22) PCT Filed: Feb. 27, 2024
(86) PCT No.: PCT/EP2024/054947

§ 371 Date: Jun. 24, 2025

(30) Foreign Application Priority Data
Mar. 2, 2023 (EP) 23159639.6

(51) Int. Cl. C03C 23/00; B23K 26/211; B23K 26/324; B23K 103/00; C03C 17/06; C03C 17/22; C03C 17/23

(52) U.S. Cl. CPC C03C 23/0025; B23K 26/211; B23K 26/324; C03C 17/06; C03C 17/225; C03C 17/23; B23K 2103/54; C03C 2217/73; C03C 2218/328

(57) ABSTRACT

An arrangement is provided with a first substrate, which is transparent in a defined wavelength range, and a second substrate arranged next to the first substrate. The first substrate and/or the second substrate have a coating formed on the side facing towards an interface between the first and second substrates and a first laser treated zone with weld lines. In the first laser treated zone, material of the first substrate and second substrate is melted mixed to bond the two substrates. The coating of the first substrate and/or second substrate has, before laser treatment, an absorption for light within the defined wavelength range of less than 10%. The coating is treated by heat generated in a second laser treated zones and/or the coating is removed by selectively melting portions the first substrate or the second substrate in third laser treatment zone.

The invention relates to an arrangement comprising a first substrate, which is transparent in a defined wavelength range, and a second substrate arranged next to the first substrate, wherein the first substrate and/or the second substrate have a coating formed on the side facing towards an interface between the first substrate and second substrate, and a first laser treated zone comprising weld lines, wherein in the first laser treated zone material of the first substrate and second substrate has been melted and mixed to bond the two substrates together. Further aspects of the invention relate to a method for manufacturing such an arrangement and the use of such an arrangement.

Hermetically sealed enclosures may be used, for example, to protect a component or components inside the enclosure from adverse environmental conditions. Applications for such a hermetically sealed enclosure can be found, for example, in electronics applications to protect sensitive electronic components, and in optical applications to encapsulate optical components. Other applications can be found, in particular, in the field of medical implants, microfluidic chips, augmented reality and sensor technology for mobility (e.g. pressure sensors).

Especially in optical applications, transparent materials for encapsulation such as glass are desirable in this context. But also, in electronic applications where wireless communication or wireless charging is desired, glass materials are advantageous over common metal housings, for example made of titanium, because these do not shield the radiation used in each case.

There are many methods to join flat glass, glass ceramic or crystalline flat pieces wafer via their interfaces, e.g. laser frit bonding, anodic bonding, contact bonding.

Further, it is principally known to stack several parts or layers on top of each other and to join them by means of laser welding. For example, Euro-pean Patent EP 3 012 059 B1 shows a method for manufacturing a transparent component for protecting an optical component. A new laser welding method is used therein.

US 2015/027168 A1 discloses a method for laser welding of transparent glass sheets. To enhance the laser bond, an absorptive film is deposited at the interface between the two glass sheets, for example in the form of an absorbent coating on at least one of the glass sheets. The absorption for the welding laser in the absorptive film is at least 10%. By means of such an absorbent coating, the laser irradiation is absorbed and its power is accumulated and converted into heat that creates a melting zone between the two glass sheets and thus bonds the sheets together.

A disadvantage of this method is that the coating has to be absorbent for the wavelength of the incident laser, thus reducing the design freedom, e.g. chemical composition for homogeneous coatings or layer thicknesses for dielectric coatings.

EP 3 812 352 A1 discloses an arrangement having a substrate stack comprising a base substrate and a cover substrate, wherein a first laser weld line is used to bond the substrates together. A second laser weld line arranged next to the first laser weld line such that a stress reduction in the first laser weld line is achieved, thus improving the mechanical stability of the substrate stack. In EP 3 812 352 A1, multilayer compounds comprising multiple layers may be used as one of the substrates to be welded. Such a multilayer compound may comprise internal coating layers which, when located at an interface to be bonded to another substrate, would negatively affect the laser welding process. Further, surfaces of a substrate which form an interface during the laser bonding process may have an optical anti-reflection coating if the coating is transparent for the wavelength of the wavelength laser. For example, a substrate with a reflective coating in the visible wavelength regime may be used in a laser bonding process using a laser emitting in the near infrared wavelength range.

There is a need for an arrangement having hermetically bonded coated substrates wherein the selection of the coating is not limited to coatings being transparent for the laser used in the bonding process.

### DISCLOSURE OF THE INVENTION

An arrangement comprising a first substrate, which is transparent so that it is transmissive for light in a defined wavelength range and enables the use of a laser welding process, and a second substrate arranged next to the first substrate is proposed, wherein the first substrate and/or the second substrate have a coating formed on the side facing towards an interface between the first substrate and second substrate and a first laser treated zone comprising weld lines, wherein in the first laser treated zone material of the first substrate and the second substrate has been melted and mixed to bond the two substrates together.

Further, the coating of the first substrate and/or second substrate has, before laser treatment and thus outside of laser treated zones, an absorption for light within the defined wavelength range of less than 10%.

The defined wavelength range in particular includes the wavelength of the laser used in the laser bonding process used to bond the first and second substrate together. The defined wavelength range is from 900 nm to 1500 nm, preferably from 1000 nm to 1100 nm.

Transparency in the context of the present disclosure means in particular that the transparent substrate is suitable for use in the laser welding process and thus allows transmission of the laser beam towards the interface between the two substrates. In particular, the transparent substrate is transmissive for the light within the defined wavelength range such that the transmission T of light having a wavelength within the defined wavelength range is more than or equal to 50%, preferably more than 60%, more preferably more than 70%. The transmission is preferably defined as T=Pₒᵤₜ/Pᵢₙ, wherein Pᵢₙ denotes the total power of light incident on the first substrate and Pₒᵤₜ denotes the power of the light transmitted through the first substrate. The transmission T may also be defined as T=1-R-A, wherein R denotes the fraction of light which is reflected and A denotes the fraction of light which is absorbed by the first substrate.

The inventors have surprisingly found that the coating of the first and/or second substrate is not required to be substantially transparent for the laser used in the laser bonding process by which the material of the first and second substrate is melted and mixed to form the bond. In order to not interfere with the laser bonding process, it is sufficient that the coating is not or at least not substantially absorbing the laser light. This allows, for example, to use a coating which is highly reflective for the wavelength range used by the bonding laser, and which is thus substantially opaque and thus non-transparent for light of the laser wavelength.

It is important to note here that a coating having only a small amount of absorption for light within the defined wavelength range, e.g. having an absorption of at most 10%, does not imply that said coating is essentially transparent having a transmission of at least 90% as this simplification does not account for reflection. Thus, the transmission or transparency T of a coating cannot be determined by only measuring the absorption A as the reflectivity R of the coating must also be considered. The transmission T is given by T=Pₒᵤₜ/Pᵢₙ=1-R-A, wherein Pᵢₙ denotes the total power of light incident on the coating and Pₒᵤₜ denotes the power of the light transmitted through the coating. The transmission T of the coating can for example be measured by comparing the transmission of a coated substrate and an uncoated substrate of the same substrate material.

Accordingly, the coating may be highly reflective within the defined wavelength range. For example, the reflection for light within the defined wavelength range may be at least 80%, preferably at least 90%, more preferably at least 95% and most preferably at least 98%.

The use of a coating with an absorption of less than 10% is in particular useful in combination with a laser bonding process wherein absorption of the energy of the laser in one of the substrates to be bonded is due to non-linear effects within the substrate as described e.g. in EP 3 812 352 A1. In such a laser welding process, a laser weld line is typically obtained by shooting a short pulsed laser beam from a laser source into the formed substrate stack with a defined wave length and energy so that a series of laser pulses is placed into the material of substrate stack. By choosing the repetition rate and a scan rate of the laser, the individual laser pulses are arranged so closely together that the resulting nonlinear absorption zone of a laser pulse within the material is in contact with a neighboring nonlinear absorption zone of a further laser pulse, or even overlaps with it, such that heat accumulation can occur. Due to the accumulated heat, the material of the substrate stack is locally melted and a continuous welding “line” can be obtained. For creating such a continuous welding line, a focus plane of the laser beam is arranged close to but not at the interface between the first and second substrates. The laser beam is arranged at a distance Hi below the interface between the two substrates such that the accumulated heat causes the material of the first and second substrate to locally melt and mix so that a hermetic bond is formed. The area, in which the accumulated heat of the incident laser causes the material of the first and second substrates to melt and to mix is designated as first laser treated zone. The material of the coating of the first and/or second substrate will typically also melt in this process and will be part of the resulting material mix. This results in the coating being effectively removed within the first laser treated zone.

Thus, in contrast to the bonding process of US 2015/027168 A1, it is not necessary to enhance absorption of the incident laser by application of an absorbent coating as the absorption occurs within one of the substrates and not within the coating. Loss of energy by reflection due to the coating can be compensated for by increasing the power of the incident laser beam.

As the absorption of the laser energy by the coating is not required to form a stable and hermetic bond between the first and second substrates, the absorption of the coating may be chosen to be much smaller than about 10%. Preferably, the absorption for light within the defined wavelength range of the coating is less than 5%, more preferably less than 1% and especially preferably less than 0.5%.

Outside of the area in which the accumulated heat of the incident laser is sufficient to locally melt the material of the first and/or second substrate, there exists a zone in which the accumulated heat is insufficient to cause the material to melt, but is sufficient to modify a material property of the coating. This area in which the accumulated heat of the incident laser causes a modification of a material property of the coating is designated as second laser treated zone.

Preferably, the arrangement has one or more second laser treated zones, wherein the coating has been selectively heat treated by heat generated within said one or more second laser treated zones. Preferably, no mixing of the materials of the first substrate and second substrate has occurred within the one or more second laser treated zones.

Such a second laser treated zone occurs in the vicinity of a first laser treated zone but can also be independently created. Second laser treated zones which are independent of first laser treated zones allow for selective heat treatment of the coating without creating a bond between the first and second substrate. For example, such an independent second laser treated zone can be obtained by arranging the focus plane of the incident laser such that a distance H₂ of the focus plane from the interface between the first and second substrates is larger than the height of the zone in which melting of the material occurs due to the accumulated heat.

By arranging the focus plane of the incident laser at a distance H₃ from a surface of a substrate such that only one of the first and second substrates is melted and thus no mixing of the materials of the two substrate occurs, but such that the coating located on the respective substrate is melted, the coating may be selectively removed. Such a zone in which the coating is selectively removed without mixing of material of the first and second substrates is designated as third laser treated zone. Such a zone may in particular be easily arranged in an area where the first and second substrate are not in direct contact with each other or where one of the first and second substrate has an opening or depression.

Preferably, the arrangement has one or more third laser treated zones in which the coating has been selectively removed by selectively melting portions of the first substrate or the second substrate, wherein no mixing of material of the first substrate and second substrate has occurred within said one or more third laser treated zones.

An advantage of the present invention is that any modification to the coating applied to the first and/or second substrate is highly localized and confined, wherein the coating is removed within the first and, if present, third laser treated zone(s) and is modified by heat within the one or more second laser treated zone. Outside of said defined zones, no damage or modification of the coating and its properties occurs.

The laser treated zones are highly localized and have a typical width in the range of from 20 μm to 80 μm in case of a first laser treated zone, a width in the range of from 30 μm to 300 μm in case of a second laser treated zone and a width in the range of from 0.5 μm to 80 μm in case of a third laser treated zone. The shape of the zones can be customized as required, wherein in particular continuous lines and individual spots are possible by scanning a laser beam over the substrate stack comprising the first and second substrate.

As the laser treatment allows selective modification and/or removal of the coating, it is preferred to apply the coating over an entire plane or the entire surface of the substrate. In particular, the coating may be applied to the entire surface of a substrate facing the other substrate.

The coating of the first substrate and/or second substrate may have at least one property selected from transmissivity, reflectivity, absorbance, color, electrical conductance, optical phase retardance, roughness, hardness and surface tension, which is affected by the heat treatment within the one or more second laser treated zones.

By selectively arranging one or more second laser treated zones, the coating can be structured independently from the placement of laser weld lines which bond the first and second substrates together. This allows the arrangement of complex structures and/or patterns.

For example, if a coating has an electrical conductivity which is modified by heat treatment within one or more second laser treated zones, it is possible to form an antenna structure suitable for receiving and/or transmitting RF signals or suitable for wireless charging, a heating structure, an electrode structure for detecting or creating an electric field, electrical pathways on the first and/or the second substrate. The pattern or structure of the coating can be formed independently from the bonding of the two substrates by arranging one or more second laser treated zones and/or third laser treated zones. Further, it is of course possible to combine several of the mentioned examples. The pattern or structure may be part of a sensor. For example, a structure for creating and detecting electric fields may be configured and arranged to detect moisture or the PH value when immersed in a liquid.

If a coating is an optical reflective coating or anti-reflective coating, in particular for visible light, for near infrared light and/or UV and wherein the reflectivity of the coating is modified within at least one of the one or more second laser treated zones, it is possible to form a pattern of coated and non-coated areas, which can serve as, an alignment structure or fiducial, label (e.g. a barcode or a QR-code) or even with sufficient resolution as diffraction grating structure,.

As used herein, UV range is from 200 nm to 380 nm, visible light or the VIS range is from 380 nm to 690 nm and the near infrared or NIR range is from 690 to 2500 nm.

The heat affected zone and thus a second laser treated zone when per-forming the laser welding process to bond the two substrates together surrounds the weld line and thus the first laser treated zone and extends about 300 μm away from the weld line. Thus, the first laser treated zone of the coating is confined to an area close to the weld lines and has a width Wₘ. Areas having a typical minimum distance of 500 μm from a weld line are not affected by the heat treatment. A width W_{haz}, which includes the widths of the first laser treated zone and the widths of the two neighboring second laser treated zones corresponds to the widths of the heat affected zone at the surface of the substrate and thus at the coating. Preferably, the laser process is carried out such that a ratio W_{haz}/Wₘ is larger than 1 and preferably less than 10, less than 5, less than 3, less than 2 and most preferably less than 1.5.

When a third laser treated zone is created, wherein the laser focus is away from the material interface and thus located further away from the coating, the zone in which the material is melted can be controlled even more precisely to selectively remove the coating and create fine, sharp patterns. A typical minimum feature size of such a pattern is 0.5 μm.

Conventional bonding processes, such as anodic bonding or gluing cause damage or modification of the properties of the coating over a wide range much larger than the typical structure sizes mentioned herein for the proposed highly localized structuring and/or modification of the coating by a laser process. Common bonding methods like fusion bonding need to heat up the whole sample to a temperature in the range of 400 °C to 600 °C, a temperature at which many optical coatings can degrade. Epoxy and glass frit bonding usually damage the coating at the areas where the epoxy glue or glass frit lines touch the coating. Those line thicknesses range from 500 μm up to several mm in width.

The arrangement may further comprise an inner coating which is arranged on inner walls not facing towards the interface between the first substrate and second substrate, in particular on sidewalls of a cavity. Accordingly, such an inner coating is arranged on a wall or surface which is not parallel to the interface between the first and second substrate. In particular in case a cavity is formed, the sidewalls may be arranged perpendicular to the interface between the first and second substrates.

The inner coating is preferably selected such that it has light absorbing or light reflecting properties. Such an inner coating may be combined with a structuring of the respective surface, in particular a structuring to increase a surface roughness. For example, the light absorbing properties of a light absorbent coating may be further enhanced by combining such an absorbent coating with a rough surface.

Preferably, the surface of the inner coating has an arithmetic average roughness between 0.05 μm and 2 μm, more preferably between 0.1 μm and 1 μm, most preferably between 0.2 μm and 0.5 μm.

The coating of the first substrate and/or the second substrate may be configured as a single layer or as a multi-layer structure. The single layer or at least one layer of the coating is preferably configured as an inorganic layer. An example for such an inorganic layer is a metal layer, a nitride layer, or an oxide layer. Suitable examples for oxide layers include, ITO, AZO, SiO₂, Al₂O₃, TiO₂, HfO₂, Ta₂O₅, ZrO₂, Nb₂O₅. Examples for suitable nitride layers include Si₃N₄ and AlN.

Suitable examples for metal and/or semiconductor layers include Ti, Si, Mo, W, Zr, Al, Cu, Nb, Ta and Cr.

Further, different materials and in particular different types of materials may be combined, either in a single layer or in multiple layers. For example, different oxides or nitrides or even mixtures of nitrides and oxides may be used.

For optical coatings such as reflective or anti-reflective coatings, at least two different dielectric materials having different refractive indices are combined in a multi-layer structure. Such a structure may in particular have alternating layers of a material having a high refractive index and a material having a low refractive index, wherein typically a high refractive index (for light of 550 nm) is grater or equal to 1.7 and a low refractive index is less or equal to 1.5.

In order to ensure that the coating has a low light absorption within the defined wavelength range, materials having a low extinction coefficient k are preferred as coating for the first and/or second substrate. Materials having an extinction coefficient <=1.10⁻³ are particularly preferred.

For example, an anti-reflective or reflective coating may be based on TiO₂ and SiO₂. In case of an anti-reflective coating, it consists of, for example, four layers, starting with the high index material. In case of TiO₂ and SiO₂, a sequence of 23 nm TiO₂, 34 nm SiO₂, 37 nm TiO₂, and 100 nm SiO₂ is suitable to act as an anti-reflective coating. The average reflectance of a glass substrate between 450 nm-650 nm is reduced to below 0.5%. Since the extinction coefficient of SiO₂ equals 0 in the VIS wavelength range, and the extinction coefficient of the TIO₂ is <1.9E-4 for λ>550 nm, the average absorptance of the coating is <0.05%.

An example for a conductive coating is indium tin oxide (ITO). When heat treated, the conductivity and thus also the electrical resistance is modified.

An example for a coating which changes color, and thus in particular changes optical properties within the VIS light range is an anti-reflective coating for the IR range. Such a coating has—when viewed with the eye in its un-damaged state—a purple reflection (e.g. placed before a black background), while yielding a green color in transmission (e.g. placed before a white background). When the glass interface or the glass interfaces carrying this coating are heated close to or beyond their softening point, the coating properties can be permanently altered. This can be by damaging or removing one or more layers, by introducing color or absorption centers and or changing the density of one or more layers or other effects causing a permanent or longer lasting modification of the coating. These effects can then lead to modified spectral response in the VIS range, e.g. a discoloration.

In principle, the same materials and structures are also suitable for the inner coating. However, in case of an inner coating, materials having a high extinction coefficient may be preferred if an absorbent property is desired.

The inner coating may have a thickness between 5 nm and 5 μm, preferably between 15 nm and 1000 nm, more preferably between 50 nm and 500 nm.

In embodiments of the invention having an inner coating with light absorbing properties, the coating may comprise at least one of the following materials: Al₂O₃, B₂O₃, Co₂O3, Cr₂O₃, CuO, Fe₂O₃, Ga₂O₃, HfO₂, In₂O₃, MgO, Nb₂O₅, NiO, Pd, Pt, Al, Ag, Mo, W, Si, SiO₂, SnO₂, Ta₂O₅, TiO₂, TaNx, (Ta,Al)N, TiCrOₓ, (Ti,Al)N, (Ti,Al)C, TiC, AlC, AlN, TiN, VO₂, WO₃, ZnO, (Al, Zn)O, ZnS, ZnSe, ZrO₂, Rare earth (RE) oxides, Sc₂O₃, Y₂O₃, Carbon, Carbon black, Ca₁₀(PO₄)₆(OH)₂), Polyimides, PMDA-ODA, PMDA-DAH, 3-ami-nopropyltrimethoxysilane coupling agent.

The coating and/or the inner coating may be applied using any known deposition technique. Examples for suitable deposition methods include Physical Vapor Deposition (PVD), especially sputtering, Chemical Vapor Deposition (CVD), especially thermal CVD, Plasma Enhanced CVD, and Atomic Layer Deposition (ALD).

The arrangement may be configured such that a hermetic enclosure is formed, wherein a cavity or function zone is enclosed within such an enclosure. As used herein, hermetically sealed means in particular an enclosure that has a helium leakage rate of less than 1-10⁻⁸ mbar·l/sec and is preferably in the range 1-10⁻¹⁰ mbar·l/sec to 1.10⁻⁹ mbar·l/sec.

For example, the first substrate of the arrangement may be configured as a cover substrate and the second substrate may be configured as a base substrate wherein the two substrates form an enclosure for a cavity or a function zone. In this example, the base substrate may have a depression, e.g. formed by etching, to define the cavity.

In a further example, the arrangement additionally comprises a further substrate, wherein the first substrate is configured as a cover substrate, the second substrate is configured as an intermediate substrate and the further substrate is configured as a bottom substrate, and wherein the three substrates form an enclosure for a cavity or a function zone. In this example, a bond between the second substrate and the further substrate may be executed in the same manner as the bond between the first substrate and the second substrate and the further substrate may have a coating arranged on the side facing towards the interface between the second substrate and the further substrate.

In case the arrangement comprises a cavity or a function zone, it is preferred that the first laser treated zone completely surrounds the cavity or function zone, wherein preferably a bond between the first substrate and the second substrate formed within the first laser treated zone is hermetic. If the arrangement comprises a further substrate, it is preferred that the bond between the second substrate and the further substrate is likewise hermetic and includes a first laser treated zone that surrounds the cavity or functional zone. The arrangement may of course comprise more than one cavity or function zone. In such a case it is preferred that all of the cavities and/or function zones are completely surrounded by a first laser treated zone so that each of the cavities and/or function zones is hermetically enclosed within the arrangement. After forming such an arrangement having multiple cavities or functional zones it is possible to cut the arrangement to separate said cavities or functional zones and thus obtain multiple parts out of a single bonded substrate stack.

Preferably, the first substrate and/or, if present, the further substrate, is selected from a glass, a glass-ceramic, silicon, sapphire, diamond or other inorganic crystals.

Preferably, the second substrate is selected from a glass, in particular a volume absorbing glass, a glass-ceramic, silicon, sapphire, diamond, other inorganic crystals, a plastic material and a metal or a metal alloy.

Suitable examples for the volume absorbing glass include in particular optical filter glass.

In a further aspect of the invention, a method for manufacturing of the herein described arrangement is provided. Accordingly, all features described with respect to the arrangement apply to the method and vice versa all features which will be described with respect to the method apply to the arrangement.

A method for manufacturing an arrangement of at least two connected substrates is proposed.

In a first step, a first substrate and a second substrate are provided and a substrate stack is formed, wherein at least one of the first substrate and the second substrate has a coating arranged on a side facing towards an interface between the first substrate and second substrate.

In a subsequent step, a first laser treated zone for bonding the first substrate and the second substrate is formed by means of laser welding, wherein at least the first substrate is transparent for the laser, such that it is transmissive for light of the welding laser, and wherein the coating, before laser treatment, has an absorption for the welding laser light of less than 10%, and wherein the first laser treated zone is formed by introducing at least one laser weld line, wherein in the first laser treated zone material of the first substrate and the second substrate is melted and mixed to bond the first substrate and the second substrate together.

In subsequent steps, a second laser treated zone is formed to selectively heat treat the coating, wherein a property of the coating is modified, and/or a third laser treated zone is formed to selectively remove the coating, wherein no mixing of material of the first substrate and second substrate occurs.

The first substrate is transmissive for light of the laser and allows the laser beam to travel through the first substrate towards the interface between the first and second substrate to form laser treated zones.

In further optional steps, a further substrate may be provided and can be arranged next to the second substrate. A bond and optional structuring of a coating can be performed as described with respect to the first and second substrates.

The method is particularly suitable for manufacturing one of the arrangements described herein, Wherein the defined laser wavelength range is chosen such that said defined wavelength range comprises the wavelength of the welding laser.

The at least one laser weld line is preferably made using an ultrashort pulse laser. Typical pulse widths are in the range of 100 fs to 100 ps. A method for carrying out such a welded joint with one or more laser welding lines is known, for example, from EP 3 012 059 B1.

The method may comprise a further examination step to be carried out after one or more first laser treated zone(s) is/are formed for assessing the quality of the formed bond within the first laser treated zone.

Preferably, the coating is selected such that the coating changes color when heat treated. In such a configuration, the substrate stack has a first observed color within areas or zones in which the coating has not been treated, has a second color within areas or zones in which the coating has been heat treated and has a third color when the coating has been removed by laser treatment. In the examination step, weld line interruptions and/or weld line inhomogeneities in the at least one laser weld line are identified by detecting the color change of heat-treated coating or the presence of untreated coating along the intended laser weld line.

Additionally or alternatively, the coating is selected such that electrical conductivity changes when heat treated. For example, the coating may have a first conductivity when untreated, a second conductivity when heat treated and no electrical conductivity when removed by laser treatment. In the examination step, weld line interruptions and/or weld line inhomogeneities in the at least one laser weld line are identified by measuring the electrical resistance between the coating within an inner zone or functional zone and a part of the coating outside of said zone. For example, if the weld line is to completely surround an inner zone defining a cavity or a functional zone, no electrical continuity should be present if the weld line is free from interruptions. If current flow is detected, at least one gap in the weld line is present.

A further aspect of the invention relates to the use of the arrangement described herein as an enclosure or as a cap for a medical implant or a sensor.

In case the arrangement is configured as a cap, the cap may be configured to be bonded to a base to form a housing for a component or a device. In particular, the cap is preferably configured to be bonded to a substrate or a header to form a housing. The formed housing is preferably hermetic and in particular suited for receiving a component such as an electronic or optoelectronic component. The housing comprises surfaces formed by the first and/or second substrate and comprises the coating applied to said first and/or second substrate and may additionally comprise an inner coating. The arrangement of the substrates and the coating of the first and/or second substrate and the inner coating may be chosen such that the formed housing has a top wall being opaque and one or more anti-reflection coated side walls. Alternatively, the top wall may be configured to be transparent and the side walls may be opaque.

It is understood that the above-mentioned features and those to be explained below can be used not only in the respective combination as shown, but also in other combinations or on their own, without leaving the scope of the present invention.

Preferred embodiments of the invention are shown in the figures and will be explained in more detail in the following description, wherein identical reference numerals refer to identical or similar components or elements.

### BRIEF DESCRIPTION OF THE FIGURES

The figures show in schematic form

FIG. 1 a schematic top view of a first exemplary arrangement of bonded stacked substrates,

FIG. 2 a cross-section side view of the arrangement of FIG. 1,

FIG. 3 an enlarged cross-section view of a bond between two substrates,

FIG. 4 an enlarged top view on a bond between two substrates,

FIG. 5 an enlarged cross-section view of a substrate having a modified coating,

FIG. 6 an enlarged top view of a substrate having a modified coating,

FIG. 7 a schematic top view of a second exemplary arrangement having an antenna structure,

FIG. 8 an enlarged cross-section view of the arrangement of FIG. 7,

FIG. 9 an enlarged photograph of two weld lines viewed from the top,

FIG. 10 a further example of a third exemplary arrangement comprising two substrates,

FIG. 11 a cross-section view of a fourth exemplary arrangement,

FIG. 12 a cross-section view of a fifth exemplary arrangement, and

FIG. 13 a cross-section view of cap cut out of the arrangement of FIG. 12.

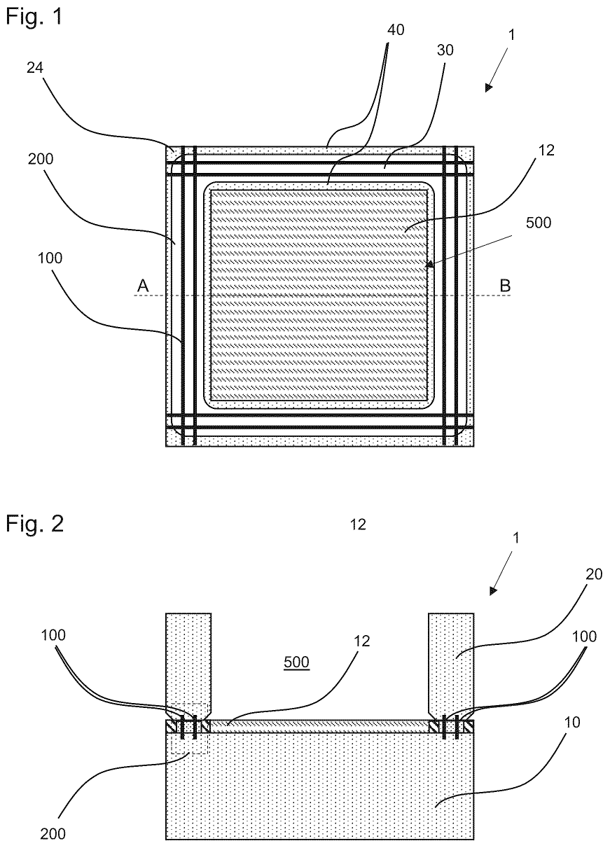

FIG. 1 shows a first exemplary arrangement 1 of two bonded stacked substrates 10, 20 (see FIG. 2) in a schematic top view. In the depicted example, the surface of a first substrate 10 that is facing towards a second substrate 20 is covered with a coating 12. In the embodiment shown in FIG. 1, the entire surface facing towards the second substrate 20 is covered by the coating 12. At least one of the substrates 10, 20 is selected to be transparent for a laser beam to enable the use of a laser bonding process to establish a hermetic bond between the two substrates 10, 20. Here, the first substrate 10 is configured to be transparent for the laser radiation.

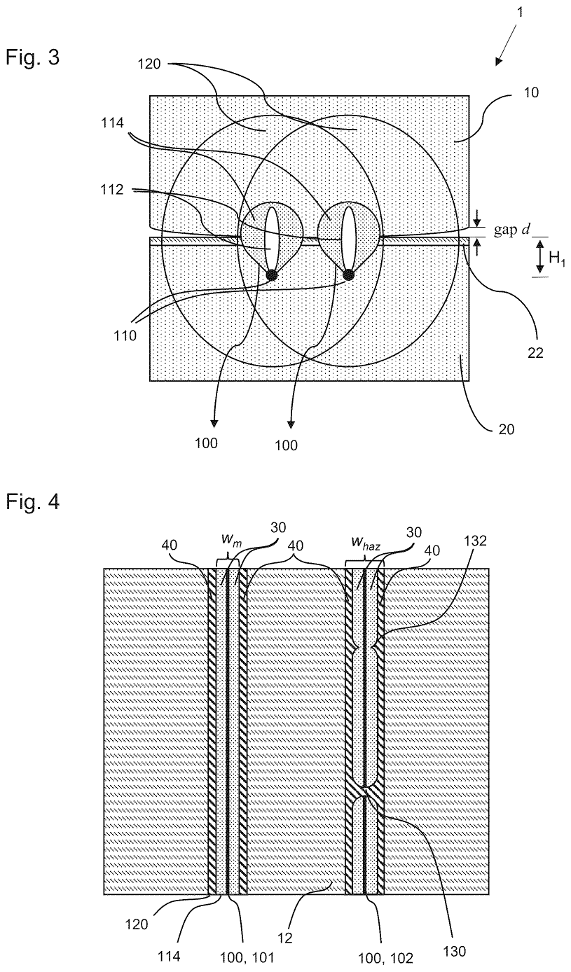

In order to securely and hermetically bond the first substrate 10 to the second substrate 20, laser weld lines 100 are arranged with a contact area 200 of the two substrates 10, 20. Within said contact area 200, a remaining gap between the two substrates 10, 20, see FIG. 3, is smaller than about 250 nm. For the hermetical bond between the two substrates 10, 20 within said contact area 200, the laser weld lines 100 are introduced by melting the material of the first substrate 10 and the second substrate 20 using an ultrashort pulse laser and cooling the resulting mixed material down again, so that the two substrates 10, 20 are joined together. The width of the laser weld lines 100 is typically in the range of approx. 20 μm to 75 μm.

As can be seen in FIG. 1, the bond lines 100 surround a space defining a cavity 500. Further, FIG. 1 shows that within a first laser treated zone 30, which comprises the welds lines 100, the coating 12 has been removed.

In an adjacent second laser treaded zone 40, the original coating 12 has been modified by heat introduced by the laser, but the coating 12 is still present.

FIG. 2 shows a schematic cross-sectional side view of the arrangement 1 of FIG. 1 along the line marked AB. In this side view, it can be seen that the first substrate 10 is configured as a solid base substrate and that the second substrate 20 is configured as a spacer substrate. The two substrates 10, 20 define a cavity 500, wherein the first substrate 10 defines a base wall und the second substrate defines side walls. The coating 12 is arranged on the side of the first substrate 10 facing towards the second substrate 20 and is arranged over the entire surface of the first substrate 10. In order to fully close the cavity 500, a further substrate 10′, see FIG. 12, can be bonded to the open side of the second substrate 20.

The interface between the two substrates 10, 20 and the bonding by means of the laser weld lines 100 will be described with respect to FIG. 3.

FIG. 3 shows an enlarged cross-sectional side view of a bond between two substrates 10, 20. In the example depicted in FIG. 3, the first substrate 10 is uncoated and only the second substrate 20 has a coating 22 located on the side facing towards the first substrate 10.

In FIG. 3, a cross-section of two weld lines 100 is visible. The weld lines 100 are formed by multiple laser pulses which overlap such that heat may accumulate within the substrates 10, 20. A laser beam used in the welding process enters the substrate stack from the top. Thus, the light of the laser beam is transmitted through the transparent first substrate 10. The region which is affected by the laser pulses is pear-shaped and represents the area of the substrates 10, 20 that has been processed by the respective laser pulse in such a way that the material has been heated above the glass transition temperature T_{G} or the melting temperature and the respective adjacent substrates 10, 20 can join together in a material bond if a gap d is less than about 250 nm. Most of the energy of a laser pulse is absorbed within an absorption zone 110 which is located at the focal plane of the laser and within which light is absorbed due to non-linear effects. The focal plane is arranged at a first depth Hi measured from the surface of the first substrate 10 including its coating. The light absorbed within the absorption zone 110 causes the material to melt within a melted zone 114. Within the melted zone 114, elongated volumes with locally lower material densities or even gas enclosures can occur periodically or aperiodically along the weld line. In the cross section, we denote this zone as “bubble-shaped” zone 112.

The melted zone 114 with the included elongated bubble-shaped zone 112 can usually clearly be identified, e.g., with a light microscope, since its density and thus the refractive index has changed with respect to the surrounding glass.

A heat affected zone 120 surrounds the melted zone 114 and indicates and area which is heated, but the accumulated heat is not sufficient to melt the material.

Portions of the coating 22 of the second substrate 20 located within the melted zone 114 will be effectively removed from the surface of the first substrate 20 as its material mixes with the molten material of the first substrate 10 and the second substrate 20. The area of the interface between the first and second substrates 10, 20 located within said melted zone 114 is referred to as a first laser treated zone.

Portions of the coating 22 of the second substrate 20 located outside the melted zone 114 but within the heat affected zone 116 are not removed, but are subject to heat from the laser. If the coating 12 is chosen appropriately, the heat can be used to selectively modify a property of the coating 22. This heat treated portion of the coating 22 is referred to as a second laser treated zone.

FIG. 4 shows two parallel weld lines 100 used to bond two substrates 10, 20 together, wherein at least one of the two substrates 10, 20 has a coating 12, 22. As can be seen in the top view of FIG. 4, each of the laser weld lines 100 has a first laser treated zone 30 having a width which corresponds to a width Wₘ of the melted zone 114, see FIG. 3, which comprises the respective laser weld line 100 and in which the coating 12, 22 has been effectively removed. Additionally, each of the first laser treated zones 30 is surrounded by second laser treated zones 40 in which heat of the laser pulses has modified the coating 12, 22. The width of the surrounding second laser treated zones 40 including the width of the first laser treated zone 30 corresponds to the total width W_{haz} of the heat affected zone 116, see FIG. 3.

In the example of FIG. 4, the coating 12, 22 of the first substrate 10 and or the second substrate 20 has been chosen to have a first color in an untreated state and to have a second color in a heat treated state. Further, the coating 12, 22 is chosen such that the color of the formed substrate stack is different from the first and second color in first laser treated areas 30 in which the coating 12, 22 has been removed. This allows easy identification of interruptions or gaps 130 within a laser weld line 100 or irregularities 132 in which a width of a laser weld line 100 is different from a set value. This is particularly useful in cases where perfect hermeticity is required as an imperfect laser weld line 100 which could allow leakage in or out of a cavity 500 can be easily identified by simple optical inspection. Thus, in the depicted example it can be easily determined that a first weld line 101 is uninterrupted and free from inhomogeneities 132, wherein a second weld line 102 has a gap 130 and an inhomogeneity 132 with reduced width.

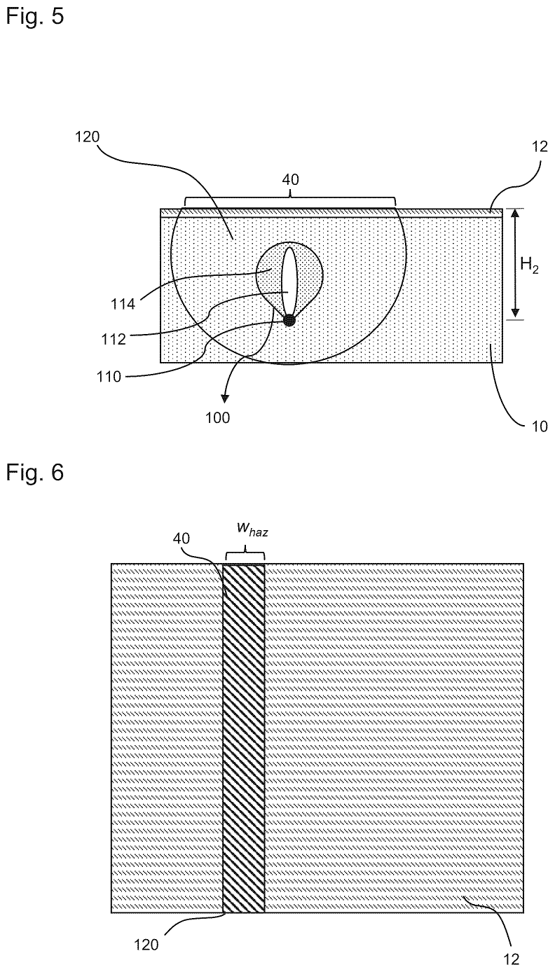

FIG. 5 shows the modification of the properties of a coating 12, 22, wherein in the depicted example a coating 12 is located on a first substrate 10. In the depicted section of the first substrate 10, the first substrate 10 is not in contact with the second substrate 20. For example, in an arrangement 1 similar to the one depicted in FIGS. 1 and 2, the portion of the first substrate 10 depicted in FIG. 5 could correspond to a portion of a bottom wall of the cavity 500.

For modification of the properties of a coating 12, 22, it is desired to subject the coating 12, 22 to heat, but not to melt the coating 12, 22 or the portions of the substrate 10, 20 which carry said coating 12,22. Thus, a focus plane in which the absorption zone 110 is located, is moved deeper into the substrate 10 and has a second depth H₂ measured from the surface including the coating 12. The melted zone 114 is then completely embedded within the substrate 10 and is not touching the surface of the substrate 10 or the coating 12. Only the heat affected zone 114 reaches the coating 12 so that the portion of the coating 12 located within the heat affected zone 114 is heat treated. This zone is referred to as a second heat treated zone 40. A second heat treated zone 40 as depicted in FIG. 5 can be used to structure the coating 12 independently from a first laser treated zone 30 as depicted in FIGS. 3 and 4. By scanning the laser pulses over the substrate 10 in a similar manner as for creating the laser weld lines 100, the coating 12 can be structured or patterned.

FIG. 6 shows a top view of a substrate 10 having a coating 12 which has been modified by heat treatment within a second laser treated zone 40. In the depicted case, the second laser treated zone 40 has a line shape having a width W_{haz} corresponding to the width of the heat affected zone 120 created during the laser processing.

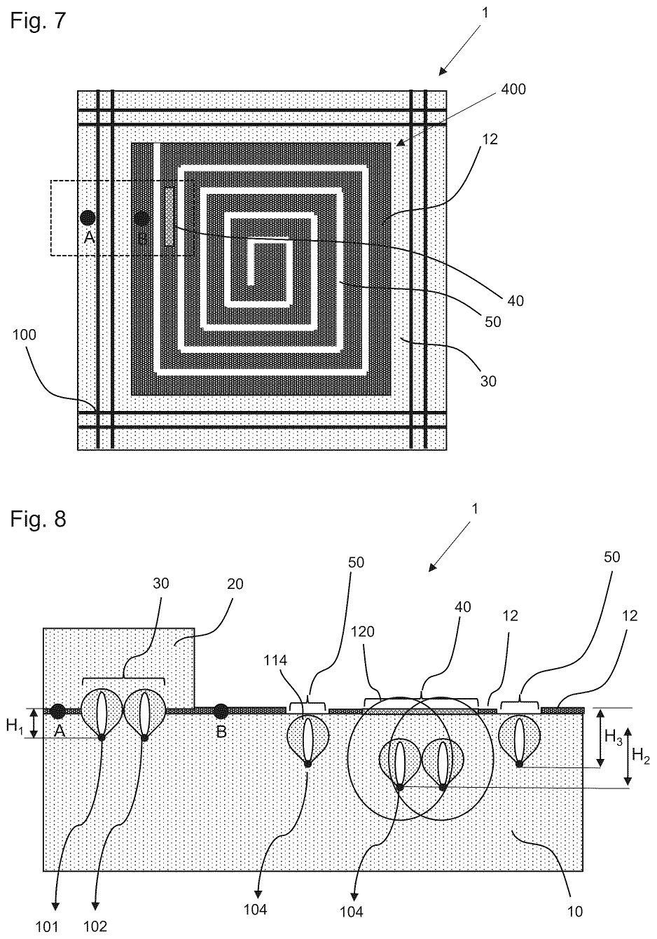

FIG. 7 shows a schematic top view of a second exemplary arrangement 1 having an antenna structure 400.

The arrangement 1 depicted in FIG. 7 comprises a substrate stack having a first substrate 10 and a second substrate 20 similar to the one described with respect to FIGS. 1 to 4. The coating 12 located on the side of the first substrate 10 facing towards the second substrate 20 is an electrically conductive coating such as an indium tin oxide (ITO) coating. The materials of the substrates 10, 20 are in this case chosen such that they are electrically non-conductive.

In a first laser treated zone 30 comprising the weld lines 100, the coating 12 has been effectively removed so that there is no conductive path from an area located inside a space defined by the weld lines 100 to the outside.

For example, there is no continuity between a point A located outside the defined space and a point B located inside the defined space. The remaining coating 12 within the defined space has been structured in a coil-like manner by preparing a third laser treated zone 50, in which the coating 12 is effectively removed, but no bond between the first substrate 10 and the second substrate 20 is formed.

Further, it is possible to influence the electrical resistance of the coating 12 by heat treatment within a second laser treated zone 40. The coating 12 within said second laser treated zone 40 is not removed, but modified by heat so that the electrical conductivity is adjusted.

FIG. 8 shows an enlarged cross-section view of the arrangement 1 of FIG. 7. From the side view of FIG. 8 it can be seen that the second substrate 20 is configured as a spacer defining side walls and is not covering the entire surface of the first substrate 10 with the coating 12. In a contact area, where the first substrate 10 with coating 12 is in direct contact with the second substrate 20, two weld lines 100 are arranged in parallel, a first weld line 101 and a second weld line 102. The heat introduced by the two weld lines 100 forms a first laser treated zone 30 in which material of the first substrate 10, the coating 12 and the second substrate 20 is molten and mixes to form a hermetic bond between the two substrates 10, 20. The material of the coating 12 is part of the material mixture, which effectively removes the coating 12 from the surface of the first substrate 10. As can be seen in FIG. 8, the focus plane for forming the first laser treated zone 30 is located at a first depths H₁. This depth is chosen such that the molten zone 114 created by the laser reaches from the lower first substrate 10 into the upper second substrate 20.

In a second laser treated zone 40, the coating 12 is not removed, but its properties are altered by the heat affected zones 120 caused by additional laser lines 104 located at a second depth H₂ from the surface of the first substrate 10. In case of a conductive ITO coating as coating 12, the electrical resistance is increased within the second laser treated zone 40 so that a resistor is formed by the selective laser treatment.

In a third laser treated zone 50, the coating 12 is effectively removed without bonding the first substrate 10 to the second substrate 20. This is achieved by forming a third laser treated zone 50 in which the melted zone of a further laser weld line 104, arranged at a third depth H₃, touches the surface of the first substrate 10 and thus causes melting of the coating 12. The molten material of the coating 12 within said third laser treated zone 50 mixes with molten material of the first substrate 10 and is thus effectively removed from the surface of the first substrate 10. As the first substrate 10 is in this case electrically insulating, a non-conductive structure is thereby formed.

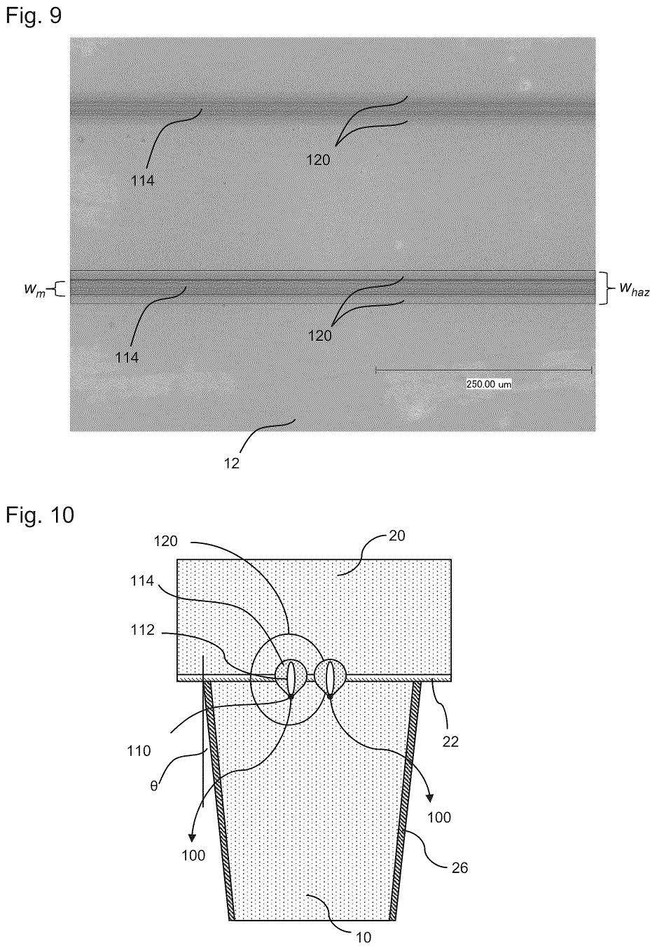

FIG. 9 shows an enlarged photograph of two laser weld lines 100 viewed from the top, wherein one of the substrates 10, 20 of the formed substrate stack has a coating 12, 22 on the side facing towards the other one of the substrates 10, 20. The coating is, in the depicted example, a broadband IR coating, that exhibits a yellow-brownish tint in the VIS, when illuminated from the top.

Within the melted zone 114, the coating 12, 22 has been completely removed by the melt pool of the material molten by the laser. Illuminated from the top, as shown in the picture shown in FIG. 9, this area appears darker than the intact, untreated coating area, since it does not reflect anymore. Most notable, no Fresnel-Reflection occurs here either, since there is no airgap between the two substrates 10, 20.

Within the heat affected zone 120 surrounding the melted zone 114, a continuous color change gradient with respect to the non-affected coating can be observed. In this example, this color change is attributed to the heat de-pendent permanent change of layer thickness, which becomes stronger the closer to the melting zone 114.

The heat affected zone 120 extends symmetrically from the melted zone 114. Its width W_{haz} is at least equal the width of the melt zone Wₘ and preferably fulfills the condition 1<W_{haz}/Wₘ<10. In the picture shown in FIG. 9, Wₘ is 17 82 m and W_{haz} is 35 μm.

FIG. 10 shows a further example of a third exemplary arrangement 1 comprising two substrates 10, 20. In the depicted example, the first substrate 10 is configured as a spacer and does not cover the entire surface of the second substrate 20. The second substrate 20 has a non-absorbent coating 22 located on the surface facing towards the first substrate 10. In this example, the coating 22 is configured as an anti-reflection coating to enhance light transmission form the second substrate 20 into the first substrate 10 and vice versa.

The first substrate 10 has an inner coating 26 located on side walls which are not parallel to the interface between the two substrates 10, 20, but arranged at an angle θ with respect to a surface normal of the interface plane. The inner coating 26 is in this example a light absorbent coating. Two weld lines 100 are used in this example to bond the two substrates 10, 20 together, wherein the coating 22 is effectively removed within the melted zones 114 and is modified within the heat affected zones 120.

The arrangement 1 of FIG. 10 can, for example, be used to form light conductive structures, wherein the structure is shielded from stray light by means of the inner coating 26 and internal transmission is enhanced by the coating 22.

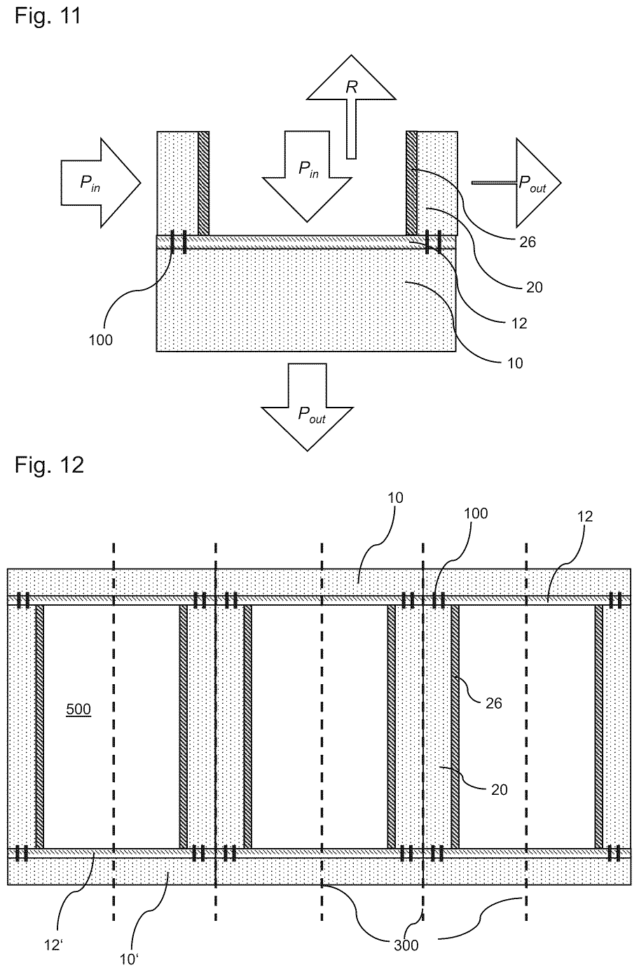

FIG. 11 shows a cross-section view of a fourth exemplary arrangement 1 configured as a cap having a top or bottom formed by a first substrate 10 and side walls formed by a second substrate 20.

The coating 12 of the first substrate 10 is in this example configured as an anti-reflection coating and the inner coating 26 located on side walls of the second substrate 20 is configured as an absorbent coating. The two substrates 10, 20 are hermetically bonded to each other by means of bond lines 100 to form a cap-like structure.

The cap is highly transparent in a first direction so that light can easily pass through the top or bottom of the cap, and is highly absorbent in a second direction so that nearly all light is blocked passing through the side walls. Such an arrangement is in particular useful for many optical devices, e.g. sensor packages, that aim to reduce stray-light.

It is important to note that we regard coating absorption A, which is not equal to transparency T, since the reflectivity R of the coating has also to be considered:

T=Pₒᵤₜ/Pᵢₙ=1-R-A<1-A

As can be seen from FIG. 11, the transmission T defined by Pₒᵤₜ/Pᵢₙ is high for a direction perpendicular to the plane of the coating 12 of the first substrate and is low for a direction perpendicular to the plane of the inner coating 26 of the second substrate.

Most important is the transmission T of light perpendicular to the coating 12. Here it is surprising that it is possible to use coatings 12 that absorb less than 10%, 5%, 1%, 0.5% in this direction. This is contrary to common knowledge that for a good laser bond that is assisted by a coating, it is required to have the coating layer to absorb at least 10% of the incident laser light.

FIG. 12 shows a cross-section view of a fifth exemplary arrangement 1. In this example, several cap-like elements are produced simultaneously by stacking large wafers as substrates 10, 10′, 20 on top of each other and subsequently separating the individual caps by dicing along dicing lines 300.

In the depicted example, a first substrate 10 is first bonded to a second substrate 20 configured as spacer. In a subsequent step, this intermediate stack is bonded to a further substrate 10′. The first substrate 10 and the further substrate 10′ are each provided with a coating 12, 12′ which is in this example configured as anti-reflection coating. Side walls of the second substrate 20 are coated with an inner coating 26 which is in this example configured as a light absorbent coating. Before dicing, multiple cavities 500 are formed.

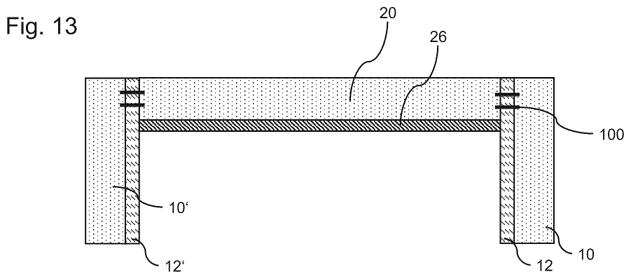

FIG. 13 shows a cross-section view of cap cut out of the arrangement 1 of FIG. 12.

The arrangement 1 of FIG. 13 has been obtained by dicing the substrate stack of FIG. 12 along the indicated dicing lines 300. The resulting arrangement 1 is similar to the arrangement 1 as shown in FIG. 11, but has highly transmissive side walls and an opaque top or bottom wall.

Although the present invention has been described with reference to preferred examples of embodiments, it is not limited thereto but can be modified in a variety of ways.

### LIST OF REFERENCE NUMERALS

1 arrangement
10 first substrate
10′ further substrate
12 coating of first substrate
12′ further coating
20 second substrate
22 coating of second substrate
24 underside of second substrate
26 inner coating
θ wall tilt angle
30 first laser treated zone
40 second laser treated zone
50 third laser treated zone
100 weld line
101 first weld line
102 second weld line
104 additional laser line
110 absorption zone
112 elongated bubble
114 melted zone
120 heat affected zone
130 weld line interruption
132 weld line inhomogeneity
200 contact area
300 dicing line
400 antenna structure
500 cavity
H₁, H₂, H₃ depth of laser focal plane
d gap between substrates
Wₘ width of melted zone
W_{haz} width of heat affected area

1. An arrangement comprising a first substrate which is transparent, and a second substrate arranged next to the first substrate, wherein the first substrate and/or the second substrate have a coating formed on the side facing towards an interface between the first substrate and the second substrate and a first laser treated zone comprising weld lines, wherein the first substrate is transparent such that it is transmissive for light within a defined wavelength range of 900 nm to 1500 nm to enable laser welding for bonding the first substrate to the second substrate by means of the first laser treated zone, wherein in the first laser treated zone material of the first substrate and second substrate has been melted and mixed to bond the two substrates together, wherein,
the coating of the first substrate and/or second substrate outside of laser treated zones has an absorption for light having a wavelength within the wavelength range of 900 nm to 1500 nm of less than 10%, and wherein the coating has been selectively heat treated by heat generated in one or more second laser treated zones, wherein no mixing of the material of the first substrate and second substrate has occurred within the one or more second laser treated zones and/or
the coating has been selectively removed by selectively melting portions the first substrate or the second substrate in one or more third laser treatment zones, wherein no mixing of material of the first substrate and second substrate has occurred within the one or more third laser treated zones.

2. The arrangement according to claim 1, wherein the absorption of the coating for light having a wavelength within the defined wavelength range is less than 5%.

3. The arrangement according claim 1, wherein the coating of the first substrate and/or second substrate has a property selected from transmissivity, reflectivity, absorbance, color, electrical conductance, optical phase retardance, roughness, hardness and surface tension, which is affected by the heat treatment within the one or more second laser treated zones.

4. The arrangement according to claim 1, wherein the electrical conductivity of the coating is modified within the one or more second laser treated zones to form at least one of
an antenna structure suitable for receiving and/or transmitting RF signals or suitable for wireless charging,
a heating structure,
an electrode structure for detecting or creating an electric field, or
electrical pathways on the first and/or the second substrate.

5. The arrangement according to claim 1, wherein the coating is an optical reflective coating or anti-reflective coating for visible light, near infrared light and/or UV light and wherein the reflectivity of the coating is modified within the one or more second laser treated zones in order to form at least one of
a non-reflecting area or reflective area,
an alignment structure or fiducial,
a diffraction grating structure,
a label,
a barcode or a QR-code.

6. The arrangement according to claim 1, wherein the coating of the first substrate and/or second substrate is a single layer or a multi-layer structure, the single layer or one layer of the multilayer coating being configured as an inorganic layer.

7. The arrangement according to claim 1, wherein an inner coating is arranged on inner walls not facing towards the interface between the first substrate and second substrate light absorbing or light reflecting.

8. The arrangement according claim 1, wherein the first substrate is configured as a cover substrate and the second substrate is configured as a base substrate, the two substrates forming an enclosure for a cavity or a function zone, or that the arrangement additionally comprises a further substrate wherein the first substrate is configured as a cover substrate, the second substrate is configured as an intermediate substrate and the further substrate is configured as a bottom substrate, the three substrates forming an enclosure for a cavity or a function zone.

9. The arrangement according to claim 1, wherein the first laser treated zone surrounds a cavity or a function zone, wherein a bond between the first substrate and second substrate formed within the first laser treated zone is hermetic.

10. The arrangement according to claim 1, wherein the first substrate and/or, if present, the further substrate (10′), is selected from a glass, a glass-ceramic, silicon, and an inorganic crystal, and/or that the second substrate is selected from a glass, a glass-ceramic, silicon, an inorganic crystal, a metal or a metal alloy and a plastic material.

11. The arrangement according to claim 1, wherein the first substrate has a transmission for light having a wavelength within the defined wavelength range of 50%.

12. A method for manufacturing an arrangement of two connected substrates, comprising the steps of
providing a first substrate and a second substrate and forming a substrate stack, wherein one of the first substrate and the second substrate has a coating arranged on a side facing towards an interface between the first substrate and second substrate;
forming a first laser treated zone for bonding the first substrate and the second substrate by means of laser welding, wherein the first substrate is transparent such that the first substrate is transmissive for light of the laser, and wherein the coating, before laser treatment, has an absorption for the welding laser light of less than 10%, and wherein the first laser treated zone is formed by introducing one laser weld line, wherein in the first laser treated zone material of the first substrate and second substrate is melted and mixed to bond the first substrate and the second substrate together;
and forming a second laser treated zone to selectively heat treat the coating, wherein a property of the coating is modified and/or forming a third laser treated zone to selectively remove the coating, wherein no mixing of material of the first substrate and second substrate occurs.

13. The method according to claim 12, wherein the arrangement includes a first substrate that is transmissive for light within a defined wavelength range which comprises the wavelength of the welding laser light.

14. The method according to claim 12, wherein the coating changes color when heat treated, the method further comprising an examination step, where weld line interruptions and/or weld line inhomogeneities in the laser weld line are identified by detecting the color change of heat treated coating or the presence of untreated coating along the intended laser weld line or wherein the coating is selected such that electrical conductivity changes when heat treated, the method further comprising an examination step where weld line interruptions and/or weld line inhomogeneities in the laser weld line are identified by measuring the electrical resistance between the coating within an inner zone or functional zone and a part of the coating outside of said zone.

15. The method according to claim 12, wherein a position of a focus of the laser is set at a first distance H₁ from the interface between the first substrate and the second substrate for forming the first laser treated zone, wherein the position of the focus of the laser is set to a second distance H₂ from the interface for forming the second laser treated zone, and wherein the position of the focus of the laser is set to a third distance H₃ from the interface for forming the third laser treated zone, wherein H₁<H₃<H₂.

16. (canceled)

17. The arrangement according to claim 2, where the absorption of the coating wherein the absorption of the coating for light having a wavelength within the defined wavelength range is less than 1%.

18. The arrangement according to claim 2, where the absorption of the coating wherein the absorption of the coating for light having a wavelength within the defined wavelength range is less than 0.5%.

19. The arrangement according to claim 6, wherein the inorganic layer is a metal layer, a nitride layer, or an oxide layer.

20. The arrangement according to claim 7, wherein the inner coating is light absorbing or light reflecting.

21. The arrangement according to claim 10, wherein the first substrate or the further substrate is an inorganic crystal selected from sapphire or diamond.
